(19) United States
(12) Patent Application Publication
(10) Pub. No.: US 2024/0336419 A1
(43) Pub. Date: Oct. 10, 2024

(54) Modified Atmosphere Packaging Unit, Method for Manufacturing Such Unit, and Use Thereof

(71) Applicant: Huhtamaki Molded Fiber Technology B.V., Leeuwarden (NL)

(72) Inventors: Harald John Kuiper, Leeuwarden (NL); Vincent Biencourt, Leeuwarden (NL); Steve Davey, Leeuwarden (NL)

(21) Appl. No.: 18/579,205

(22) PCT Filed: Jul. 16, 2021
(86) PCT No.: PCT/NL2021/050455

§ 371 Date: Jan. 12, 2024

(51) Int. Cl. B65D 77/20; B32B 27/08; B32B 27/18; B32B 27/30; B32B 27/36; B65B 5/04; B65B 7/28; B65D 25/14; B65D 65/46; B65D 81/20

(52) U.S. Cl. CPC B65D 77/2024; B32B 27/08; B32B 27/18; B32B 27/306; B32B 27/36; B65B 5/04; B65B 7/2842; B65D 25/14; B65D 65/466; B65D 81/2076; B32B 2255/10; B32B 2255/20; B32B 2262/067; B32B 2264/104; B32B 2307/7163; B32B 2307/7376; B32B 2439/40

(57) ABSTRACT

The present invention relates to a modified atmosphere packaging unit, and method for manufacturing such unit and the use thereof. A modified atmosphere packaging unit according to the invention comprises: a product receiving body configured for holding a product, and having a bottom part and a wall part; a flange configured for attaching a seal thereon for closing the product receiving body; a seal or lid that is attached to the flange, wherein the product receiving body and the flange are a moulded fiber product comprising: an amount of plant-based fiber material; an amount of wet strength agent; and wherein the product receiving body and the seal or lid is provided with a biodegradable barrier-coating and/or a biodegradable barrier-film.

The present invention relates to a modified atmosphere packaging (MAP) unit for food products. These packaging units are made from moulded pulp material and are used to contain, store, transport and/or display a range of products, such as fresh food like (vegetarian) burgers or meat, cereals, nuts, snacks, margarine or butter, fruit, vegetables, and other products. The packaging unit may relate to containers, carriers, cases, cups, plates, trays etc.

Conventional modified atmosphere packaging units are manufactured from plastic material. This gives rise to plastic pollution in rivers, seas and oceans, and has a negative impact on the global environment. There is a requirement to move from these plastic packaging units to fiber-based packaging units to make a plastic transition to make it possible to provide consumers with packaging solutions that are more sustainable. This is further stimulated by regulations like the European Single Use Plastics directive that also drives the need for sustainable fiber-based packaging solutions.

The plastic packaging units involve materials like polypropylene and polyethylene terephthalate (PET) having a plastic top seal film to provide a barrier to maintain a modified atmosphere in the packaging unit. Gas can be flushed through the packaging unit to increase the shelf life of the food in the packaging unit. This flushing gas may relate to a gas mixture, for example 30% CO₂ and 70% nitrogen to extend shelf life and prevent early oxidation that may result in a quality loss of the product with an off-smell, off-taste and/or deterioration of the food product.

Further problems with conventional packaging units, especially modified atmosphere packaging units, is that these packaging units are often not biodegradable or compostable for the end-user, which is often the consumer/household.

The present invention has for its object to obviate or at least reduce one or more of the above-stated problems in conventional modified atmosphere packaging units and to provide a modified atmosphere packaging unit that is more sustainable and/or has improved recycling possibilities.

For this purpose the present invention provides a modified atmosphere packaging unit, comprising:
a product receiving body configured for holding a product, and having a bottom part and a wall part;
a flange configured for attaching a seal thereon for closing the product receiving body;
a seal or lid that is attached to the flange,
wherein the product receiving body and the flange are a moulded fiber product comprising:
an amount of plant-based fiber material; and
an amount of wet strength agent; and
wherein the product receiving body and the seal or lid is provided with a biodegradable barrier-coating and/or a biodegradable barrier-film.

The product receiving body is configured for holding the product and is provided with a bottom part and a wall part. This product receiving body may relate to a container, tray, cup, plate, carrier, case, etc., which is capable of receiving, containing and/or carrying a food product. Such food product may relate to a meat product, (fresh) vegetables and fruits, cereals, nuts, margarine and butter, snacks et cetera. The desired shelf life of these products typically depends on product type. For example, meat products typically require a shelf life of 8 to 30 days, while products like breakfast cereals or other dry food products may normally require a shelf life of 1 to 12 months. Other products, like dairy products as margarine or butter may normally require a shelf life between 2 to 26 weeks. For these products an extended shelf life can be achieved by providing a modified atmosphere inside the packaging unit. Such modified atmosphere can be provided by flushing the packaging units with a gas mixture, such as the aforementioned mixture of 30% CO₂ with 70% nitrogen. It will be understood that other mixtures or gasses can also be envisaged in accordance to the present invention.

Providing the moulded fiber product a biodegradable packaging unit is achieved. This is improved by providing biodegradable barrier-coating and/or biodegradable barrier-film. This provides a packaging unit that is more sustainable. In addition, the application of a modified atmosphere extends the shelf-life of products, which contributes to the reduction of waste. In a presently preferred embodiment the modified atmosphere packaging unit is compostable to further improve the sustainability.

In the context of this invention, degradable relates to degradation resulting in loss of properties, while biodegradable relates to degradation resulting from the action of microorganisms such as bacteria, fungi and algae. Compostable relates to degradation by biological process to yield carbon dioxide (CO₂), water, inorganic compounds and biomass. Preferably, the modified atmosphere packaging unit is home compostable (e.g. according to EN 13432:2000, EN 14046:2004 in Europe and AS 5810 “biodegradable plastics suitable for home composting” in Australia).

The product receiving body is at its upper edge provided with a flange that is configured for attaching a seal or lid thereon for closing the product receiving body such that the modified atmosphere can be maintained in the packaging unit.

The product receiving body and the flange are a moulded fiber product and comprise an amount of plant-based fiber material in a (pulp) matrix comprising wood and/or non-wood fiber material, with wood material comprising soft wood (long fibers) and/or hard wood (short fibers) and/or so-called kraft fibers, wherein the fibers are preferably refined.

In a presently preferred embodiment of the invention the matrix further comprises an amount of microfibrillated cellulose (MFC). In the context of the present invention this may also include nanofibrillar cellulose or cellulose nanofibers or nanocellulose. MFC preferably originates from cellulose raw material of plant origin. The use of MFC enhances the fiber-fiber bond strength and further improves the reinforcement effect in the matrix.

According to such embodiment of the invention MFC provides improved barrier properties. MFC may fill the gaps between the fibers and, therefore, has gas barrier properties, for instance an enhanced oxygen barrier. When MFC is modified, e.g. the carboxyl groups are replaced by a hydrophobic group, the modified MFC can enhance also the water vapor barrier. Tests have additionally shown a good wet strength and the aforementioned barrier properties. Barrier properties may include oxygen and/or grease and/or moisture barriers. It is believed that the oxygen barrier properties are achieved by the ability of MFC to form a dense network involving intramolecular bonds and/or intermolecular bonds. For example, intramolecular bonds such as covalent bonds and/or intermolecular bonds such as hydrogen bonds and/or covalent bonds and/or Van der Waals interaction and/or ionic bonds. Preferably, said dense network comprises hydrogen bonds. Also, as mentioned earlier, the relatively small MFC particles fill the gaps between the fibers in the fiber matrix and therefore enhances the (gas) barrier properties further.

Optionally, some hydrophobic elements, such as alkanes, oils, fats, and greasy substances and/or other suitable hydrophobic elements, are added to an MFC layer to further improve the water barrier properties. This may involve modification of the hydroxyl groups, for example on the surface of the micro fibrils chemically and/or by absorption of polymers, for example.

A further advantage of the use of MFC is the improved printability, including digital printing possibilities, especially when combined with one or more additional fillers, such as calcium carbonate and/or calcium bicarbonate and/or clay. A further effect of the use of MFC is the tendency to (slightly) roughen the surface (Bendtsen roughness). In addition or as an alternative, MFC may reduce cost by reducing the weight or grammage by increasing the amount of fillers. This may also enhance the visual appearance of the packaging unit.

Preferably, the amount of microfibrillated cellulose is in the range of 1.2 wt % to 10 wt % of the moulded fiber product, preferably in the range of 1.8 wt % to 5 wt %, and most preferably in the range of 2 wt % to 4.2 wt %. Besides desired barrier properties, experiments showed an improved modified atmosphere packaging unit performance, for example an increased tensile strength of the modified atmosphere packaging unit.

The modified atmosphere packaging unit according to one of the presently preferred embodiments of the invention also comprises an amount of a biodegradable aliphatic polyester. The biodegradable aliphatic polyester may relate to poly(butylene succinate) also referred to as PBS, polybutylene sebacate terephthalate also referred to as PBST, polyhdroxyalkanoate also referred to as PHA, for example including polyhdroxybutyraat also referred to as PHB and/or poly(3-hydroxybutyrate-co-3-hdroxyhexanoate) also referred to as PHBH and/or poly(3-hydroxybutyrate-co-3-hydrovalerate) also referred to as PHBV, polycaprolactone also referred to as PCL, poly(lactic acid) also referred to as PLA, poly(glycolic acid) also referred to as PGA, polybutyleneadipate-terphthalate also referred to as PBAT and also known with its commercial name ecoflex, and/or other suitable components, such as poly(alkylene dicarboxylate) other than PBS, PBAT and PBST, poly(lactic- co-glycolic acid) also referred to as PLGA, including mixtures or blends. It is noted that for example PBAT and PBST comprise an aromatic part and aliphatic part. Therefore, PBAT and PBST may also be referred to as biodegradable aliphatic-aromatic polyester (or biodegradable aromatic polyester) and are, therefore, included in the group of biodegradable aliphatic polyesters. An example of a blend is a blend of PBAT and PLA, also known with its commercial name Ecovio, or a blend of PBAT and PBS, or another suitable blend that is preferably home compostable. In some of the presently preferred embodiments of the invention the biodegradable aliphatic polyester is bio-based. This further improves the sustainability of the packaging unit of the invention.

The presence of the biodegradable aliphatic polyester in the matrix of the moulded fiber product contributes to the reduction of swelling of the packaging unit.

In one of the preferred embodiments of the invention the amount of biodegradable aliphatic polyester in the moulded fiber matrix is in the range of 0.5 wt % to 20 wt % of the product receiving body, preferably in the range of 1 wt % to 16 wt %, more preferably in the range of 1 wt % to 15 wt %, even more preferably in the range of 2 wt % to 10 wt %, even more preferably in the range of 5 wt % to 9 wt %, and most preferably in the range of 6.5 wt % to 8 wt %.

In a further embodiment of the invention the amount of biodegradable aliphatic polyester in the moulded fiber matrix is in the range of 0.1 wt % to 12 wt % of the product receiving body, preferably in the range of 0.5 wt % to 8 wt %, more preferably in the range of 1 wt % to 5 wt %, and most preferably in the range of 2 wt % to 4 wt %.

By applying an amount of biodegradable aliphatic polyester in one of the aforementioned ranges, the sustainability and packaging characteristics of the modified atmosphere packaging units according to the present invention are significantly improved. Applying an amount of biodegradable aliphatic polyester in these ranges provides modified atmosphere packaging units that are both stable and strong, and further improve the denesting properties of the modified atmosphere packaging units. Another advantage when using biodegradable aliphatic polyester in a modified atmosphere packaging unit is the constancy of size or dimensional stability.

In an embodiment of the invention the biodegradable aliphatic polyester in the moulded fiber matrix comprises fiber that preferably have a length of above 1.2 mm. Providing fibers of the biodegradable aliphatic polyester achieves a network of moulded and biodegradable aliphatic polyester fibers in the moulded fiber matrix. This further improves the strength of the packaging unit. In addition, it may further improve barrier properties.

In another embodiment of the invention the fibers comprise PBS and/or PBST and/or PBAT. Experiments have shown that the PBS fibers effectively melt into the matrix and form a strong network. This is also possible with PBST and/or PBAT fibers. It is noted that for example PBAT and PBST comprise an aromatic part and aliphatic part. Therefore, PBAT and PBST may also be referred to as biodegradable aliphatic-aromatic polyester (or biodegradable aromatic 10 polyester) and are, therefore, included in the group of biodegradable aliphatic polyesters.

It will be understood that combinations of MFC and/or biodegradable aliphatic polyesters may further improve the mentioned effects and advantages. As a further example, a combination of biodegradable aliphatic polyester, such as PBS, PBAT, PBST with cellulose fibers significantly reduces the swelling of the packaging material. These cellulose fibers may be a mixture of short fiber hard wood pulp (e.g. birch) and long fiber soft wood pulp. In a presently preferred embodiment the long cellulose fibers have an average length of about 2 mm to 3 mm, and preferably about 2.5 mm, the short fibers have an average length of about 0.5 mm to 1.2 mm, and preferably about 0.9 mm.

Combinations of MFC and/or biodegradable aliphatic polyesters in the matrix of the moulded fiber product enhance the oxygen barrier of the modified atmosphere packaging unit. This enables preserving the quality of the products. By having such barrier in the matrix of the moulded fiber product itself, the requirements for the thickness of the (bio) film to achieve for example an oxygen transfer rate (OTR)<1 ml/24 hr. m² (23° C. 50% RH or even 23° C., 80% RH) is achievable with simplified barrier-film and/or barrier-coating constructions at reduced thickness. Such combination also provides a water vapour transfer barrier. In addition, such mixture may enhance stiffness, strength, and furthermore reduce the weight of required modified atmosphere packaging unit. This may improve manufacturing speed because the same strength and stiffness can be achieved by lower weight products, that additionally may also reduce the energy requirements for the drying step as well as heating temperature.

The matrix of the moulded fiber product of the modified atmosphere packaging unit according to the present invention further comprises an amount of wet strength agent. Applicable wet strength agents (or resins) include Xelorex additives (or BIM DS2801 DS2802 etc dry strength agents). Xelorex showed in experiments that it may provide a functional additive for a container according to the present invention. The wet strength agent improves the release of the modified atmosphere packaging unit from the mould in the manufacturing process of the modified atmosphere packaging unit.

In a presently preferred embodiment the amount of wet strength agent is in the range of 0 wt % to 3 wt % of the product receiving body, more preferably in the range of 1 wt % to 2.5 wt %. This wt % relates to the supplied additive. The active component in this mostly water based dispersion is, therefore, typically in the range of about 0.15 wt % to about 0.5 wt %. Further wt % of wet strength agents will be presented in relation to the supplied additive.

The combination of MFC, biodegradable aliphatic polyester and wet strength agent provides the desired product properties that enable the use of the modified atmosphere packaging unit.

The modified atmosphere packaging unit according to the invention comprises a biodegradable barrier-film and/or biodegradable barrier coating. The film preferably relates to a multi-layer film. This film and/or coating enable maintenance of the modified atmosphere conditions inside the packaging unit.

According to the invention a seal or lid is provided, which is preferably also biodegradable and preferably compostable. This seal or lid is configured for covering the product receiving body.

The seal or lid is attached to the flange of the modified atmosphere packaging unit. The seal is preferably manufactured from a biodegradable material and may involve the use of biodegradable aliphatic polyesters, optionally in combination with a paper layer. Optionally, the seal or lid, with optional multi-layer barrier construction and optional paper layer, is used for enhancing the decoration and paper look and feel of the entire packaging unit, and preferably to have the same Oxygen Transfer Rate (OTR) and Water Vapor Transmission Rate (WVTR) barrier properties as the packaging container to make them gas flushable with different gases like 30% CO₂, 70% N₂ to preserve the packed food for longer shelf life times.

The seal or lid can be adhered to the flange, thereby effectively providing a strong bonding to the fiber material in the matrix of the moulded fiber product that comprises MFC and biodegradable aliphatic polyesters. It is believed that this provides a strong bonding such that the adherence of the seal to the flange is effective. Experiments have shown that separate glue or glue material is not needed and is preferably omitted from the modified atmosphere packaging unit, thereby contributing to the overall sustainability of the modified atmosphere packaging unit of the invention. Surprisingly, the strong bonding of the seal or lid to the flange is sufficient for maintaining the modified atmosphere conditions in the packaging unit. The bonding can be further improved by providing the flange that extends outwardly from the wall part of the product receiving body with one or more compressed areas. By providing the flange with a compressed area or areas the rigidity and stability of the flange is significantly improved. This provides a more stable surface area for attaching thereto the seal or lid such that the sealing properties of the modified atmosphere packaging unit are improved. This also further reduces the need for the application of glue or glue material to attach the seal to the modified atmosphere packaging unit. It will be understood that this contributes to the overall sustainability of the modified atmosphere packaging unit of the invention. The compressed area may extend over substantially the entire flange or may alternatively comprise a number of local areas that are preferably distributed over the entire flange surface.

In a further preferred embodiment of the invention the plant-based fiber material comprises an amount of non-wood fiber material.

The non-wood fiber material is also referred to as natural and/or alternative fibers. Providing an amount of these fibers in the matrix of the moulded fiber product provides a natural feel to the modified atmosphere packaging unit and/or improves the overall strength and stability of the modified atmosphere packaging unit. Such fibers may comprise fibers from different origin, specifically biomass fibers from plant origin.

This biomass of plant origin may involve plants from the order of Poales including grass, sugar cane, bamboo and cereals including barley and rice. Other examples of biomass of plant origin are plants of the order Solanales including tomato plants of which the leaves and/or stems could be used, for example plants from the Order Arecales including palm oil plants of which leaves could be used, for example plants from the Order Maphighiales including flax, plants from the Order of Rosales including hemp and ramie, plants from the Order of Malvales including cotton, kenaf and jute. Alternatively, or in addition, biomass of plant origin involves so-called herbaceous plants including, besides grass type plants and some of the aforementioned plants, also jute, Musa including banana, Amarantha, hemp, cannabis etc. In addition or as an alternative, biomass material origination from peat and/or moss can be applied.

In another preferred embodiment the (lignocellulosic) biomass of non-wood plant origin comprises biomass originating from plants of the Family of Poaceae (to which is also referred to as Gramineae). This family includes grass type of plants including grass and barley, maize, rice, wheat, oats, rye, reed grass, bamboo, sugar cane (of which residue from the sugar processing can be used that is also referred to as bagasse), maize (corn), sorghum, rape seed, other cereals, etc. Especially the use of so-called nature grass (defined by “Staatsbosbeheer” as grass clippings originating from natural landscape) provides good results when manufacturing modified atmosphere packaging units. Such nature grass may originate from a natural landscape, for example. This family of plants has shown good manufacturing possibilities in combination with providing a sustainable product to the consumer. Optionally, the (lignocellulosic) biomass of non-wood plant origin comprises material from the coffee plant (Coffea) in the family Rubiaceae.

Optionally, this biomass is used in combination with other biomass.

In a presently preferred embodiment of the modified atmosphere packaging unit the non-wood fiber material provides at least 5 wt % of the matrix of the product receiving body, preferably at least 10 wt %, preferably at least 50 wt %, even more preferably at least 80 wt %, even further more preferably at least 85 wt %, and most preferably at least 92.5 wt %. It was shown that modified atmosphere packaging units can be manufactured effectively from the non-wood fiber material in such significant amounts.

In a further preferred embodiment of the invention the matrix of the moulded fiber product further comprises an amount of calcium carbonate and/or calcium bicarbonate.

Providing an amount of calcium carbonate and/or calcium bicarbonate provides a smoother surface to the product receiving body. The calcium (bi) carbonate, or alternatively the clay (filler), provides such smoother surface because the filler is filling the gaps between the fibers and smoothens the surface and enhances printability/decoration and improves denesting because less rough fibers at the surface tend to hook into each other. In addition, it further reduces fiber swelling and penetration of compounds of the product into the matrix and/or fibers. Furthermore, dewatering is improved. This enables higher machine speeds in manufacturing the modified atmosphere packaging units and/or reduces the energy costs as less water needs to be evaporated in the drying process. In addition, providing an amount of calcium carbonate and/or calcium bicarbonate enhances the strength and stiffness properties, and also improves the oxygen transfer rate (OTR) barrier properties and can smoothen the surface to improve printability, in mould labelling, decoration in general. Calcium carbonate and/or calcium bicarbonate can be provided as a so-called filler material to the matrix and/or can be used in combination with other materials.

In a presently preferred embodiment the amount of calcium carbonate and/or calcium bicarbonate is in the range of 0 wt % to 2 wt. % of the matrix of the moulded fiber product, more preferably in the range of 0.4 wt % to 1.2 wt %.

Preferably, the calcium carbonate and/or calcium bicarbonate is applied as filler material in combination with MFC in the matrix of the moulded fiber product. Preferably, the matrix comprises a mixture of MFC and calcium carbonate and/or calcium bicarbonate, more preferably with an amount of 5 wt % to 10 wt % of the matrix of the moulded fiber product. In this mixture the amount of calcium carbonate is in the range of 1 wt % to 12 wt % of the mixture, more preferably in the range of 2.5 wt % to 11 wt %, and most preferably in the range of 5 wt % to 10 wt %. This even further improves product properties, such as strengthening of the product, smoothening of the surface of the product, enhancing denestability, improving printability, and being less sensitive for swelling.

In a presently preferred embodiment the matrix of the moulded fiber product comprises an amount of fibers, wherein at least 80 percent of the fibers has a length above 1.1 mm, preferably above 1.2 mm. This provides a significant length increase of the fibers that are provided in the moulded pulp material. This results in an increased strength-weight ratio for the modified atmosphere packaging units.

In a further preferred embodiment of the invention the product receiving body comprises a biodegradable barrier coating. The coating may include an amount of graphene and/or other suitable material, such as a silicon based material, chitosan, alginate, wax, polyethylene, silica gel. The silicon based coating preferably comprises a silicon oxide and/or silane. This provides a flexible coating that maintains its integrity also when gripping the modified atmosphere packaging unit and placing it in a fridge or freezer, for example. In addition, or as an alternative a starch and/or cellulose coating can be applied.

The use of the coating improves the barrier properties that are already achieved with the matrix of the moulded fiber product. Optionally, the coating is provided on another layer, such as a paper layer, to act as a seal or lid of the packaging unit.

In a further preferred embodiment of the invention the product receiving body comprises a biodegradable multi-layer as a barrier-film which is provided on the inner surface of the modified atmosphere packaging unit and comprises:
an inner cover layer comprising an amount of a biodegradable aliphatic polyester;
a first intermediate layer of a biodegradable material for connecting and/or sealing adjacent layers;
a functional layer comprising a vinyl alcohol polymer;
a second intermediate layer of a biodegradable material for connecting and/or sealing adjacent layers; and
an outer cover layer comprising an amount of a biodegradable aliphatic polyester.

The multi-layer area is applied in addition to or as an alternative to a coating. The use of the multi-layer further improves the barrier properties that are already achieved with the matrix of the moulded fiber product. Optionally, the multi-layer is provided on another layer, such as a paper layer, to act as a seal or lid of the packaging unit.

Specifically, with the use of the multi-layer and/or coating the modified atmosphere packaging unit according to the invention shows a significant reduction in the water vapor transmission rate (WVTR). For example, these conventional capsules show a WVTR of up to 200 g/m² d under normal conditions of use. Experiments with a multi-layer and/or coating according to the present invention shows a WVTR below 5 g/m² d, and below 4 g/m² d, and even below 3 g/m² d. It will be understood that this is a significant improvement in WVTR. This also reduces loss of aroma significantly. In addition, this maintains food quality and improves shelf-life. Furthermore, this enables the omission of additional packaging layers or holders as a secondary packaging. This enables a full biodegradable modified atmosphere packaging unit with minimal material cost as well as a home and industrial compostable packaging unit. Also, the oxygen barrier is improved. Experiments showed that the oxygen transfer rate (OTR, at 23° C. and 0% RH) can even be reduced to below 2 ml/m² d. In a presently preferred embodiment of the invention the OTR is below 1 ml/m² d and more preferably even below 0.1 ml/m² d. This improves freshness of the compounds in the capsule and the shelf-life.

According to an embodiment of the present invention comprising a biodegradable multi-layer, preferably a laminated multi-layer, this layer comprises at least five material layers. It will be understood that additional layers can also be provided in accordance to the present invention.

The inner and outer cover layers of the multi-layer construction comprise an amount of a biodegradable aliphatic polyester, preferably of the type described earlier in relation to the matrix of the moulded fiber product. The inner and outer cover layer may also comprise a biodegradable composition of materials, such as a combination of starch and one of the aforementioned biodegradable aliphatic polyesters, such as PBS and/or PLA and/or PBAT and/or PBST. It is noted that for example PBAT and PBST comprise an aromatic part and aliphatic part. Therefore, PBAT and PBST may also be referred to as biodegradable aliphatic-aromatic polyester (or biodegradable aromatic polyester) and are, therefore, included in the group of biodegradable aliphatic polyesters. This combination improves the surface properties of the biodegradable (laminated) multi-layer, and also of the modified atmosphere packaging unit provided therewith. In addition, this includes the so-called wipeability of the packaging unit. Wipeability relates to the possibility to remove stains from the surface and reducing or even preventing penetration into the material. Especially such penetration should be avoided. Also, it may provide more possibilities for promoting the compostable effect of the modified atmosphere packaging unit. Also, water barrier properties can be improved to reduce the penetration of water into the modified atmosphere packaging unit and thereby reducing ridging problems and/or preventing the modified atmosphere packaging unit from being stuck in the beverage preparation machine, for example.

In addition, the (laminated) multi-layer comprises a functional (central) layer that comprises a biodegradable and compostable polyvinyl alcohol, also referred to as a vinyl alcohol polymer, including co-polymers. This function layer contributes to the multi-layer properties, such as acting as a gas barrier. For example, the functional layer may provide an effective oxygen (O₂) barrier. This improves shelf-life of the food product(s) in the modified atmosphere packaging unit.

In a presently preferred embodiment the vinyl alcohol polymer comprises a highly amorphous vinyl alcohol polymer (HAVOH), including copolymers, such as butandiol vinyl alcohol co-polymer (BVOH). Such polymer or polymer mixture also provides an effective barrier, especially a gas barrier, and more specifically an oxygen (O₂) barrier. Such barrier can effectively be used to further improve the shelf-life of the raw material. In addition, this also reduces food waste, thereby further improving the sustainable effects of the modified atmosphere packaging unit according to the present invention. Experiments showed a surprisingly effective oxygen (O₂) barrier, especially at relative humidities up to 60% as compared to conventional materials. An example of BVOH is G-Polymer (Mitsubishi).

As a further advantage, vinyl alcohol polymers are mouldable and extrudable. This renders it possible to co-extrude the laminated multi-layer as a co-extruded laminated multi-layer, optionally together with the basic material of the modified atmosphere packaging unit, such as the moulded fiber, or alternatively moulded fluff (fiber), pulp material. The co-extruded material can be moulded or deepdrawn. This enables efficient and effective manufacturing processes for the modified atmosphere packaging unit of the present invention. The efficiency can even be improved further by recycling the remainders after punching the material into the manufacturing process.

The inner and outer cover layers are separated from the central functional layer by an intermediate layer, to which can also be referred to as a tie layer. Such intermediate layer is substantially of a biodegradable material and connects and/or seals its adjacent layers. Preferably, the intermediate layers improve or at least contribute to maintaining the desired properties of the central functional layer, such as acting as a gas barrier. For example, the intermediate layers seal the central functional layer against liquid penetration to maintain the gas barrier properties of the functional layer. The (compostable) multi-layer can be manufactured using different techniques, for example using blown film and melt cast extrusion techniques, co-injection optionally with integrated outer and intermediate layers, and (paper) coating.

In one of the presently preferred embodiments the multi-layer comprises an inner and outer layer of Ecovio, and a functional layer (thickness of about 4 μm) of the aforementioned G-polymer, that are separated with an intermediate or tie layer. The total multilayer thickness is about 80 micron (μm), for example a symmetrical multi-layer that comprises a 34 μm Ecovio inner layer, a 4 μm PBAT tielayer, a 4 μm G-Polymer, a 4 μm PBAT tielayer, and a 34 μm Ecovio outer layer, and as another example an asymmetric multi-layer that comprises a 48 μm Ecovio inner layer, a 4 μm PBAT BTR tielayer, a 4 μm G-Polymer, a 4 μm PBAT tielayer, and a 20 μm 90% Ecovio+10% Ecoflex outer layer. The Ecovio layer may comprise one or more Ecovio products like FT2341, FS2312, F2332 and other related products.

In another one of the presently preferred embodiments the multi-layer comprises an inner and outer Ecovio layer, and a G-polymer (thickness of about 8 μm), that are separated with intermediate or tie layers. The total multi-layer thickness is about 150 μm, for example a multi-layer that comprises a 61 μm Ecovio inner layer, a 10 μm PBAT tielayer, a 8 μm G-Polymer, a 10 μm PBAT tielayer, and a 61 μm Ecovio outer layer.

In another one of the presently preferred embodiments the multi-layer comprises a PBS inner and outer layer, a G-polymer (4 μm), that are separated with intermediate or tie layer(s), and having a total thickness of the multi-layer of about 80 μm, for example a multi-layer that comprises a 34 μm bioPBS inner layer, a 4 μm PBAT tielayer, a 4 μm G-Polymer, a 4 μm PBAT tielayer, and a 34 μm bioPBS outer layer.

In another one of the presently preferred embodiments the multi-layer comprises a PBS inner and outer layer, a G-polymer (8 μm), that are separated with intermediate or tie layer(s), and having a total thickness of the multi-layer of about 80 μm, for example a multi-layer that comprises a 32 μm bioPBS inner layer, a 4 μm PBAT tielayer, a 8 μm G-Polymer, a 4 μm PBAT tielayer, and a 32 μm bioPBS outer layer.

Preferably, as is also illustrated in the aforementioned embodiments, the thickness of the individual layers is within the range of 1.5 μm to 65 μm, preferably in the range of 1.5 μm to 30 μm, and the total thickness of the multi-layer is in the range of 20 μm to 150 μm.

Optionally, the functional layer is positioned asymmetrically in the multi-layer to further enhance the barrier properties. This positioning is achieved by having a different thickness of one or more of the corresponding layers on both sides of the functional layer, preferably the outer or cover layer on the food side of the multi-layer has a reduced thickness. This asymmetric positioning of the functional barrier layer enables thickness reduction (and cost reduction) of the layer in contact with the raw material in the modified atmosphere packaging unit and enables use of the thick (er) layer to provide a good bonding. The principle of bonding the film to the fiber surface, preferably without the use of glue or adhesive layers, is based on bringing the multi-layer structure close to the melting point of the layer that needs to bond/attach to the modified atmosphere packaging unit. Therefore, a thicker layer at the fiber tray side enables a better mechanical bonding due to the fibers of the modified atmosphere packaging unit. The layers in contact with the raw material that is located inside the modified atmosphere packaging unit can be as thin as possible and just thick enough to protect the functional (barrier) layer, for example if this layer is water soluble and moisture sensitive. This further improves the modified atmosphere packaging unit.

In such presently preferred embodiment the inner and outer cover layer have a thickness that is preferably in the range of 20 μm to 50 μm, more preferably in the range of 10 μm to 40 μm. As mentioned the inner (food side) and outer cover layer may have a different thickness. It will be understood that different combinations of layers and thicknesses can be made.

The biodegradable multi-layer system may comprise one or more functional layers. This improves the performance of the barrier layers and/or increases the flexibility to provide multiple barriers for optionally different properties. For example, it may have multiple barriers for oxygen, or also for odour barriers. For instance, a 9-multi-layer system may have a total thickness in the range of 100 μm to 150 μm. The outer and inner cover layers made of a blend of PBAT and PLA or PBS, can have a thickness in the range of 30 μm to 35 μm. Two functional layers, preferably comprising a polyvinyl alcohol, may have a thickness in the range of 3.5 μm to 4 μm. An additional flexibility layer made of blend of biopolymers, for example with PBS, PBAT and/or PBST, is introduced and has a thickness in the range of 30 μm to 40 μm.

It will be understood that several other multi-layer systems can be envisaged in accordance to the present invention. For example, such systems may include biofilms comprising PHA, PHB, PHBV etc. An advantage of PHA, PHB and similar products is that these are fully biobased, (home) compostable and fully fossil free.

As an alternative to the earlier mentioned butandiol vinyl alcohol co-polymer (BVOH) (BVOH), an ethylene vinyl alcohol (EVOH) can be used as functional layer in the multi-layer. It is also possible to combine the function of layers in a multi-layer having multiple functional layers to further enhance the barrier properties thereof. In a possible embodiment of the invention the EVOH functional layer is provided in a multi-layer with a polyethylene (PE) inner and outer layer as a separator separated from the functional layer with two intermediate or tie layers.

The Modified Atmosphere Packaging unit according to the present invention provides a barrier as a result of a joined effect of the matrix of the moulded fiber product and the multi-layer and/or coating provided on the inner surface of the product receiving body. The barrier of the Modified Atmosphere Packaging unit according to the present invention provides barrier properties that achieve a maximum Oxygen Transfer Rate (OTR) of 0.3 ml/pack.day that corresponds to a maximum of 10 ml O₂/m².24 h, and a maximum Water Vapour Transfer Rate (WVTR) of 0.2 g/pack.day that corresponds to a maximum of 6.4 g/m².24 h.

The present invention further relates to a method for manufacturing a modified atmosphere packaging unit, the method comprising the steps of:
providing a modified atmosphere packaging unit according to an embodiment of the present invention;
filling the product receiving body with the product; and
sealing the product receiving body.

The method provides some same or similar effects and advantages as described in relation to the modified atmosphere packaging unit. The modified atmosphere packaging unit is preferably provided as a so-called smooth moulded fiber packaging unit that is thermal formed or in-mould dried. These smooth moulded packaging units are provided with a barrier film or a barrier coating and can be top sealed with a barrier seal having the same or alternative barrier film or barrier coating. As an alternative to such wet moulded manufacturing processes, the modified atmosphere packaging unit can also be manufactured in a dry forming process for evolving forming and pressing the packaging unit. In both cases the packaging units are coated or laminated with a barrier, preferably on the inside of the product receiving body. A coating as described earlier can be deposited on the smooth moulded fiber modified atmosphere packaging units, for example using spray coating, airless pulsed coating application, atomic deposition coating techniques, vacuum deposit coating techniques, co-extrusion coating techniques, 3D printing techniques. This enables to provide a thin layer on the inside of the modified atmosphere packaging unit to provide or improve the barrier layer. A multi-layer film can be laminated on the surface of the packaging unit, for example.

The modified atmosphere packaging unit can be provided using conventional wet forming techniques. As already mentioned in the former paragraph, in one of the presently preferred embodiments of the invention the modified atmosphere packaging unit is provided using dry forming, preferably using so-called fluffy pulp. This fluffy pulp may comprise virgin and/or any suitable alternative fiber, for example. In this dry forming process, after cooking and disclosing the pulp, additives like oil sizing and/or water sizing and/or (biobased) binders can be added to the pulp on the paper machine. That pulp can be dried and supplied as sheets or reels. These reels or sheets can be fed into a hammer mill, or similar device, also known as defibrator, that separates compressed rolls or sheets of cellulose pulp into individual, loose fibers, which are then transported to the web forming system, involving up to 100% fiberization and minimal or zero nits. The fluffy pulp contains herewith already some barrier properties that are relevant for the 3D formed product to be provided. After the hammer mill and before the web forming (fluffy pulp blanket), the individual fibers can be sprayed/treated/mixed with dry binders or additional functional additives to support the 3D product properties like oxygen barrier, water vapour barrier, grease resistance, oil resistance and/or water resistance. The web can be formed (fluffy pulp blanket) and sprayed with additional functional coatings/additives. Then the web can optionally be sandwiched between thin layers of tissue paper to keep the web in place, avoiding that short fibers and dust particles contaminate the line and production environment and are lost. The production of fluffy pulp fibers, the addition of additives and/or the formation of the web are preferably performed in a controlled RH and temperature chamber to avoid fluctuations in moisture and avoid quality changes in the end products. The 3D moulded fiber products can be manufactured from the web in a tool in a press at pressing forces in the range of 100-500 ton/m² (equals 10-50 bar). The products will have so called embedded barrier properties. Optionally, the products can be post-processed. Such post-processing may involve applying a lamination film/barrier film, which can be a biobased, synthetic, natural biofilm. Alternatively, the 3D products can optionally be coated in a post-processing step with a biodegradable (bio) based coating or synthetic coating to meet the product quality, stiffness/strength, chilled conditions resistance and barrier properties for the specific application and to meet the customer needs.

The advantage of dry forming process and manufacture of 3D molded fiber products is that the energy consumption is only 20% to 35% in comparison with wet forming technology based moulded fiber production. The carbon footprint is therefore also only ⅕ or ⅓ compared to the wet forming technology. The production speed of the dry forming process is, depending on shape and format and complexity, a factor 2 to 7 higher as the wet forming and in-mould drying process. The investment in tooling and machinery for the dry forming process is considerably lower as well, making it very attractive for replacing plastic products by fiber based products using the dry forming technology.

The invention further also relates to the use of such modified atmosphere packaging unit.

Such use provides the same or similar effects as described in relation to the modified atmosphere packaging unit and/or method for manufacturing such unit.

Further advantages, features and details of the invention are elucidated on the basis of preferred embodiments thereof, wherein reference is made to the accompanying drawings, in which:

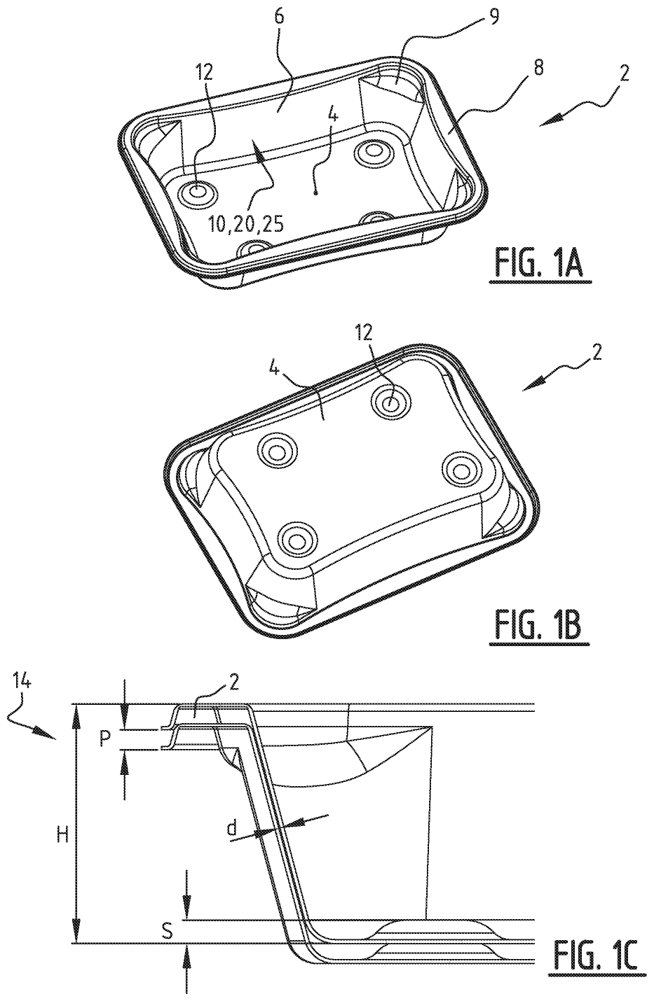

FIG. 1A illustrates an embodiment of the packaging unit according to the present invention;

FIG. 1B illustrates a bottom view of the packaging unit of FIG. 1A;

FIG. 1C illustrates a stack of packaging units illustrated in FIG. 1A-B;

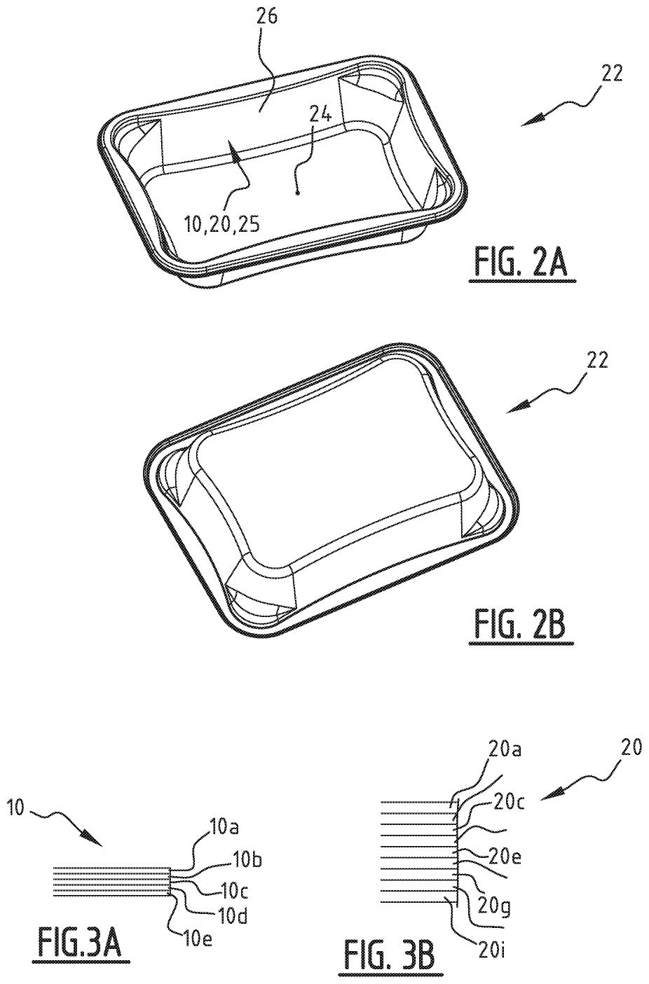

FIGS. 2A-B illustrates different views of an alternative packaging unit according to the present invention;

FIGS. 3A-B shows different embodiments of multi-layer that can be applied to the packaging units of FIG. 1 or 2 and further figures;

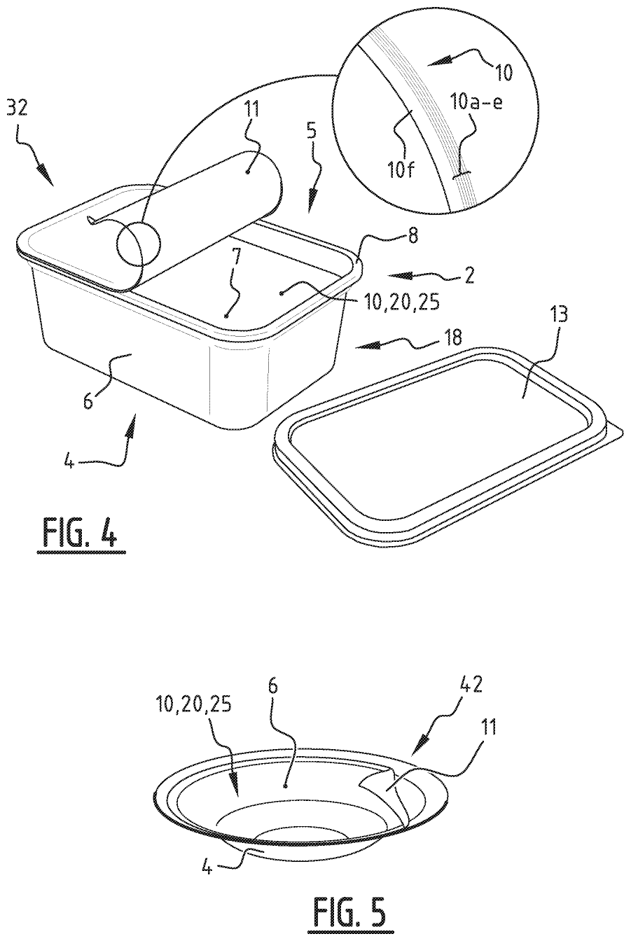

FIG. 4 illustrates an alternative packaging unit according to the invention for margarine according to the invention;

FIG. 5 illustrates a plate-shaped packaging unit according to the present invention;

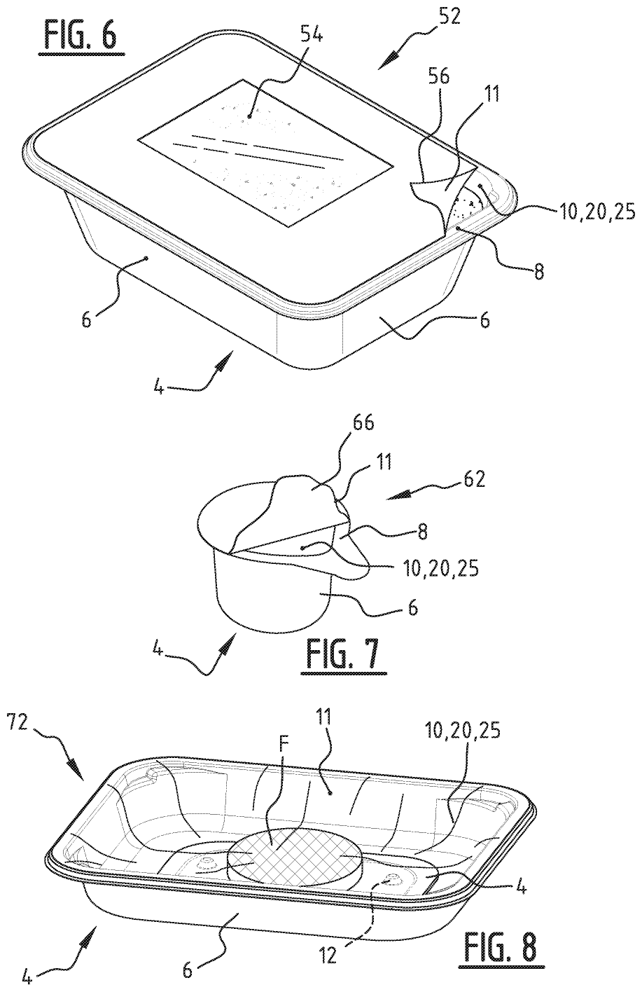

FIG. 6 illustrates a ready-to-eat meal tray according to the present invention;

FIG. 7 illustrates a cup-shaped packaging unit according to the present invention; and

FIG. 8 illustrates a meat tray according to the present invention.

Packaging unit 2 (FIGS. 1A-C) comprises bottom 4 and side wall 6. Side wall 6 is provided with rim 8 that provides a surface for the top seal or lid (not shown). The corners of wall 6 are provided with supports 9 that also act as denesting features. Bottom part 4 is provided with additional supports 12 enabling the products to rest on supports 12 and provide an open space between bottom part 4 and the product in packaging unit 2.

In the illustrated embodiment height H of packaging unit 2 is about 32 mm. Packaging units 2 can be nested in stack 14. Pitch distance P between two packaging units 2 in stack 14 is in the illustrated embodiment about 3.5 mm. Height S of supports 12 is about 3.5 mm. Due to the angled side wall 6 and supports 9, side walls 6 of nested packaging units 2 are provided at a small distance d of about 0.3 mm. This enables effective denesting of packaging units 2 from stack 14. The inner surface of side wall 6 is provided with multi-layer barrier 10, 20 or coating 25.

Alternative packaging unit 22 (FIGS. 2A-B) is also provided with bottom part 24 and side walls 26. Side walls 26 and bottom 24 are provided with multi-layer film 10, 20, or coating 25.

In the illustrated embodiment laminated multi-layer 10 (FIG. 3A) comprising first cover layer 10a, first intermediate layer 10b, central functional layer 10c, second intermediate layer 10d, and second cover layer 10e. It will be understood that other layers can be added to multi-layer 10. It will be understood that laminated multi-layer 10 can be applied to the (illustrated) packaging units or to further alternative embodiments that are not illustrated.

An alternative biodegradable laminated multi-layer 20 (FIG. 3B) comprises first cover layer 20a, first intermediate layer 20b, first functional layer 20c, second intermediate layer 20d, central flexible layer 20e, third intermediate layer 20f, second functional layer 20g, fourth intermediate layer 20h, and second cover layer 20i. It will be understood that other layers can be added to multi-layer 20. It will be understood that laminated multi-layer 20 can be applied to the packaging units that are illustrated or are not illustrated.

Multi-layer 10,20 may comprise different materials and combinations as is described earlier. These embodiments have been tested and appear to fulfil the requirements in relation to the desired barrier properties. The thickness of individual layers can be determined taking into account the product that needs to be brought into the packaging unit, whereby it is possible to apply functional layer(s) that is/are positioned asymmetrically (i.e. somewhat out of the center of layer 10,20) in multi-layer 10,20.

Further alternative packaging unit 32 (FIG. 4) comprises bottom 4 and side wall 6. Food product 7 relates to margarine or butter. The inner surface of packaging unit 32 is provided with multilayer 10, 20 or coating 25. Opening 5 is covered by top seal 11 comprising multi-layer 10 being connected to flange 8, and optionally comprising another paper layer or other suitable layer. Additionally, lid 13 is provided that optionally can be positioned over seal 11.

Plate 42 (FIG. 5) is provided with bottom 4, sidewall 8 and flange 8 to which is connected seal 11. Lid or seal 11 can be manufactured from a multi-layer 10, 20, for example. Wall 6 and bottom 4 can be provided with multi-layer 10, 20 or alternative food with a coating 25 that in the illustrated embodiment preferably comprises an amount of graphene and/or is silicon based.

Ready-to-eat meal tray 52 (FIG. 6) comprises bottom or side walls 6. The inner surface of packaging unit 52 is provided with multilayer 10, 20 or coating 25. Connected to flange 8 is seal or lid 11 preferably from multi-layer material 10, 20 that in the illustrated embodiment is provided with window 54. Optionally, lid 11 is provided with an extension 56 to enable the user to remove seal or lid 11 from flange 8.

Cup 62 (FIG. 7) comprises bottom 4, wall 6, flange 8 and attached thereto seal or lid 11. Seal 11 and the inner surface of wall 6 and bottom 4 are provided with a multi-layer 10, 20 and/or coating 25. Optionally, extension 66 is provided to enable a user to open packaging unit 62.

Meat tray 72 (FIG. 8) provide with bottom 4, wall 6, product support 12 that supports food product. In the illustrated embodiment seal 11 is a transparent seal that comprises multi-layer 10, 20 and/or coating 25. Wall 6 and bottom 4 are provided with multi-layer 10, 20 and/or coating 25.

The MAP unit illustrated in FIG. 1A-C is used in a test. The surface of these packaging units is about 0.031 m², such that 1 m² of film equals 32 trays in total surface. Under normal conditions the barrier(s) limit the OTR to a maximum of 10 ml O₂/m².24 h, and limit the WVTR to a maximum of 6.4 g/m².24 h.

Further tests with these packaging units were performed with the packaging unit comprising different multi-layers with EVOH as a functional layer. The top seal is manufactured from the same multi-layer. Results are shown in Table 1, including results after deep drawing the film, wherein the film comprises PE-EVOH-PE layers with intermediate tie layers.

TABLE 1
Multilayer PE/EVOH/PE

| | Thickness | OTR | WVTR |
|---|---|---|---|
| Thickness Multilayer micron | EVOH | ml/m2*24 h | g/m2*24 hr |
| 60 | 5 | 0.54 | 4.8 |
| 90 | 10 | 0.3 | 2.48 |

With the thinning factor 0.63 (after lamination)

| | | | |
|---|---|---|---|
| 37.70 | 3.14 | 0.9 | 8 |
| 56.55 | 6.30 | 0.5 | 4.1 |

*OTR at 23° C. and 0% RH
*WVTR at 38° C. and 90% RH (tropical conditions)

To achieve a further increase in shelf life, depending on the food type and specific conditions, the EVOH barrier layer can be increased to 15 micron, for example.

Further tests have been performed with different embodiments of modified atmosphere packaging units. These tests were performed with different amounts of MFC, and are provided with or without the use of additional chemicals, specifically Xerolex and/or AKD.

Tests were performed with several MFC types, including with Bang & Bonsomer/Betulium MFC, two type MFC25 and MFC65 (sugar beet residue based), and MFC from COSUN/Duynie (sugar beet residue based) and MFC from Graanul, Biotech in Estonia (wood based). Stiffness and strength improvements in tensile strength were measured, in RCT Ring crush compression test (important cardboard parameter), in burst index and tear strength resistance. The improvement effects at dosage levels of 2% MFC (as received. 8-20% dry matter, so 0.16-0.4% wt %) are in the range of 10-30% improvement. The possible increase in roughness (Bendsten) for the packaging units that comprise MFC as compared to the reference packaging unit could be compensated by applying calcium carbonate or clay as filler. In particular, an increase of 10-30% (in ml/min at 0.74 kPa) was measured.

The results show the applicability of the packaging unit as MAP units.

The present invention is by no means limited to the above described preferred embodiments thereof. The rights sought are defined by the following claims, within the scope of which many modifications can be envisaged.

1. A modified atmosphere packaging unit comprising:
a product receiving body configured for holding a product, and having a bottom part and a wall part;
a flange configured for attaching a seal thereon for closing the product receiving body; and
a seal or lid that is attached to the flange,
wherein the product receiving body and the flange are a moulded fiber product comprising:
an amount of plant-based fiber material; and
an amount of wet strength agent,
wherein the product receiving body and the seal or lid is provided with a biodegradable barrier-coating and/or a biodegradable barrier-film.

2. The modified atmosphere packaging unit according to claim 1, wherein at least a part of the amount of plant-based fiber material is microfibrillated cellulose.

3. The modified atmosphere packaging unit according to claim 2, wherein the amount of microfibrillated cellulose is in the range of 1.2 wt % to 10 wt % of the moulded fiber product.

4. The modified atmosphere packaging unit according to claim 1, wherein the moulded fiber product comprises an amount of biodegradable aliphatic polyester.

5. The modified atmosphere packaging unit according to claim 4, wherein the biodegradable aliphatic polyester comprises an amount of one or more of PBS, PHB, PHA, PCL, PLA, PGA, PBST, PBAT, PHBH and PHBV.

6. The modified atmosphere packaging unit according to claim 4, wherein the amount of biodegradable aliphatic polyester in the moulded fiber product is in the range of 0.5 wt % to 20 wt. %.

7. (canceled)

8. The modified atmosphere packaging unit according to claim 4, wherein the amount of biodegradable aliphatic polyester in the moulded fiber product is in the range of 0.1 wt % to 12 wt % of the unit.

9. The modified atmosphere packaging unit according to claim 1, wherein the plant-based fiber material comprises an amount of non-wood fiber material, wherein the non-wood fiber material comprises material from the family of Poaceae.

10. (canceled)

11. The modified atmosphere packaging unit according to claim 9, wherein the amount of non-wood fiber material is at least 5 wt. %.

12. The modified atmosphere packaging unit according to claim 1, further comprising an amount of calcium carbonate and/or calcium bicarbonate.

13. The modified atmosphere packaging unit according to claim 1, wherein the moulded pulp material comprises an amount of fibers, wherein at least 80% of the fibers has a length above 1.1 mm.

14. The modified atmosphere packaging unit according to claim 1, wherein the barrier-coating is a silicon based coating, wherein the silicon based coating comprises a silicon oxide and/or silane.

15. (canceled)

16. The modified atmosphere packaging unit according to claim 1, wherein barrier-coating comprises an amount of graphene, chitosan, alginate, wax, polyethylene, or silica gel.

17. The modified atmosphere packaging unit according to claim 1, wherein the product receiving body comprises a biodegradable multi-layer that is provided on the inner surface of the modified atmosphere packaging unit and comprising:
an inner cover layer comprising an amount of a biodegradable aliphatic polyester;
a first intermediate layer of a biodegradable material for connecting and/or sealing adjacent layers;
a functional layer comprising a vinyl alcohol polymer;
a second intermediate layer of a biodegradable material for connecting and/or sealing adjacent layers; and
an outer cover layer comprising an amount of a biodegradable aliphatic polyester.

18. The modified atmosphere packaging unit according to claim 17, wherein the thickness of the individual layers is within the range of 1.5 to 50 μm.

19. The modified atmosphere packaging unit according to claim 17, wherein the functional layer is positioned asymmetrically in the multi-layer.

20. The modified atmosphere packaging unit according to claim 1, wherein the product receiving body comprises a coating that comprises an amount of graphene.

21. A method for manufacturing a modified atmosphere packaging unit, the method comprising the steps of:
providing a modified atmosphere packaging unit comprising;
a product receiving body configured for holding a product, and having a bottom part and a wall part;
a flange configured for attaching a seal thereon for closing the product receiving body; and
a seal or lid that is attached to the flange,
wherein the product receiving body and the flange are a moulded fiber product comprising:
an amount of plant-based fiber material; and
an amount of wet strength agent,
wherein the product receiving body and the seal or lid is provided with a biodegradable barrier-coating and/or a biodegradable barrier-film;
filling the product receiving body with the product; and
sealing the product receiving body.

22. The method according to claim 21, wherein the step of providing the modified atmosphere packaging unit comprises dry forming using a dry fluffy pulp.

23. A method for using a modified atmosphere packaging unit comprising:
a product receiving body configured for holding a product, and having a bottom part and a wall part;
a flange configured for attaching a seal thereon for closing the product receiving body; and
a seal or lid that is attached to the flange,
wherein the product receiving body and the flange are a moulded fiber product comprising:
an amount of plant-based fiber material; and
an amount of wet strength agent,
wherein the product receiving body and the seal or lid is provided with a biodegradable barrier-coating and/or a biodegradable barrier-film.
